(19) United States
(12) Patent Application Publication
(10) Pub. No.: US 2015/0200035 A1
(43) Pub. Date: Jul. 16, 2015

(54) NANO PARTICLE COMPLEX AND METHOD OF FABRICATING THE SAME

(71) Applicants: LG INNOTEK CO., LTD., Seoul (KR); Seoul National University R&DB Foundation, Seoul (KR)

(72) Inventors: Yu Won Lee, Seoul (KR); Gwang Hei Choi, Seoul (KR); Jin Kyu Lee, Seoul (KR); Yun Ku Jung, Seoul (KR)

(73) Assignees: SEOUL NATIONAL UNIVERSITY R&DB FOUNDATION, Seoul (KR); LG INNOTEK CO., LTD., Seoul (KR)

(21) Appl. No.: 14/346,246

(22) PCT Filed: Jul. 18, 2012
(86) PCT No.: PCT/KR2012/005715

§ 371 Date: May 22, 2014

(30) Foreign Application Priority Data
Sep. 20, 2011 (KR) 10-2011-0094913

(51) Int. Cl. H01B 1/10; H01B 1/06

(52) U.S. Cl. CPC H01B 1/10; H01B 1/06; Y10S 977/774; Y10S 977/932; B82Y 30/00

(57) ABSTRACT

Disclosed are a nano particle complex and a method of fabricating the same. The nano particle complex includes a nano particle including a compound semiconductor; and a protective layer surrounding the nano particle and including a metal oxide.

### TECHNICAL FIELD

The embodiment relates to a nano particle complex and a method of fabricating the same.

### BACKGROUND ART

According to the related art, quantum dots are fabricated through a dry chemical scheme, in which the quantum dots are fabricated by using a metal organic chemical vapor deposition (MOCVD) based on the lattice mismatch with respect to a substrate prepared under the vacuum state. The dry chemical scheme has the advantage in that nano particles formed on the substrate can be simultaneously arranged and observed. However, the dry chemical scheme requires expensive synthesis equipment and makes it difficult to synthesize the quantum dots having the uniform size in large quantity. In order to solve the above problem, a wet chemical scheme has been developed, in which the quantum dots having the uniform size are synthesized by using a surfactant.

According to the wet chemical scheme for fabricating the quantum dots, the nano particles are prevented from being conglomerated by the surfactant and the adsorption degree between the crystal surface of the nano particle and the surfactant is adjusted to synthesize the quantum dots having the uniform size and various shapes. In 1993, Bawendi Group has succeeded, for the first time in the world, the synthesis of CdSe quantum dots having the uniform size through the wet chemical scheme by using trioctylphosphineoxide (TOPO) and trioctylphosphine (TOP) as surfactants and dimethylcadmium ((Me)₂Cd) and selenium as semiconductor precursors. In addition, Alivisators Group has developed a method of synthesizing CdSe quantum dots in a more safety manner by using hexadecylamine (HDA), trioctylphosphineoxide, and trioctylphosphine as surfactants and cadmium oxide (CdO) and selenium as semiconductor precursors.

Thereafter, various studies and research have been pursued to form a shell on a surface of CdSe by using a semiconductor compound having a higher bandgap in order to improve the light emission characteristic of the quantum dots and to enhance the photo stability and environmental stability. For instance, the semiconductor compound includes CdSe/ZnS, CdSe/ZnSe, CdSe/CdS, and ZnSe/ZnS (see, Korean Patent Registration No. 10-0376405).

However, in the case of the quantum dot having the core/shell structure, if the shell is thick, an interfacial surface may become unstable due to the lattice mismatch between a core semiconductor material and a shell semiconductor material, so the quantum efficiency may be lowered. For this reason, the shell is fabricated in a thin thickness. Therefore, although the shell material can stabilize the surface state of the core quantum dot, it may not transfer electrons and holes to the core after absorbing light, so there are limitations in terms of the light efficiency and photo stability of the quantum dot and the environmental stability.

### DISCLOSURE OF INVENTION

### Technical Problem

The embodiment provides a nano particle complex having the improved efficiency and stability and a method of fabricating the same.

### Solution to Problem

A nano particle complex according to the embodiment includes a nano particle including a compound semiconductor; and a protective layer surrounding the nano particle and including a metal oxide.

According to one embodiment, the protective layer is deposited on an outer surface of the nano particle.

According to one embodiment, the compound semiconductor of the nano particle includes a first metal element, and the metal oxide includes an oxide of a second metal element different from the first metal element.

According to one embodiment, the nano particle includes a group II-VI compound semiconductor and the protective layer includes an oxide of a group II element.

According to one embodiment, the nano particle includes a core including a first group II-VI compound semiconductor; and a shell surrounding the core and including a second group II-VI compound semiconductor.

According to one embodiment, the protective layer directly makes contact with the shell.

According to one embodiment, the metal oxide is an oxide of a metal different from a group II element included in the shell.

According to one embodiment, the nano particle includes a compound of a first group II element and a second group II element, and the protective layer includes an oxide of the first group II element or the second group II element.

According to one embodiment, the metal oxide includes one selected from the group consisting of a cadmium oxide, a zinc oxide, a tin oxide, an aluminum oxide, and a titanium oxide.

A nano particle complex according to one embodiment includes a nano particle including a compound semiconductor; and a protective layer deposited on an outer surface of the nano particle and including an oxide.

According to one embodiment, the nano particle has a diameter in a range of 1 nm to 10 nm and the protective layer has a thickness in a range of 2 Å to 10 nm.

A method of fabricating a nano particle complex according to one embodiment includes the steps of forming a nano particle including a compound semiconductor; and forming a protective layer by depositing an oxide on an outer surface of the nano particle and including an oxide.

According to one embodiment, the forming of the protective layer includes adding an organometallic compound to a solution including the nano particle; and forming a metal oxide by decomposing the organometallic compound.

According to one embodiment, the organometallic compound includes one selected from the group consisting of carboxylate and alkoxide.

According to one embodiment, a nucleophillic catalyst is added to the solution including the nano particle.

According to one embodiment, the nucleophillic catalyst includes one selected from the group consisting of amine and phosphine.

According to one embodiment, the forming of the nano particle includes mixing a first metallic precursor with a second metallic precursor; reacting the first metallic precursor with the second metallic precursor; and forming the compound semiconductor including a first metal element derived from the first metallic precursor and a second metal element derived from the second metallic precursor.

### Advantageous Effects of Invention

The nano particle complex according to the embodiment includes a protective layer having oxide. Thus, the protective layer can effectively protect the nano particles from the external moisture and/or oxygen.

In addition, the protective layer can be formed through the deposition process. That is, the oxide is deposited around the nano particles to form the protective layer. Thus, the protective layer may have the compact structure. Therefore, the protective layer can effectively protect the nano particles.

### BRIEF DESCRIPTION OF DRAWINGS

FIG. 1 is a sectional view showing a nano particle complex according to the first embodiment;

FIG. 2 is a sectional view showing a nano particle complex according to the second embodiment;

FIG. 3 is a sectional view showing a nano particle complex according to the third embodiment;

FIG. 4 is a sectional view showing a nano particle complex according to the fourth embodiment;

FIGS. 5 to 7 are views showing intensity of light having the wavelength converted by a nano particle complex according to experimental examples 1 to 3 and a nano particle according to comparative examples 1 to 3; and

FIG. 8 is a view showing the modification degree of a nano particle of comparative example 2 and a nano particle complex of experimental example 2 by a halogen lamp having the power of 200W.

### MODE FOR THE INVENTION

A nano particle complex according to one embodiment includes a nano particle and a protective layer.

The nano particle may include a compound semiconductor. In detail, the nano particle may include group II-VI compound semiconductors. In detail, the group II element of the compound semiconductor may include one selected from the group consisting of Cd, Zn, Pb and Hg. In addition, the group VI element of the compound semiconductor may include one selected from the group consisting of S, Se and Te. In more detail, the compound semiconductor may include one selected from the group consisting of CdSe, ZnSe, PbSe, HgSe, CdS, ZnS, PbS, HgS, CdTe, ZnTe, PbTe and HgTe. The nano particle can be formed by using a single material as a whole.

In addition, the nano particle may include a core and a shell. That is, the nano particle may have the core/shell structure. The core may include first group II-VI compound semiconductors and the shell surrounding the core may include second group II-VI compound semiconductors. In addition, the shell may have the multi-layer structure. The core of the nano particle may include CdS or CdSe. For instance, the nano particle may include the CdSe/ZnS, CdSe/ZnSe/ZnS, CdS/ZnS or CdSe/CdZnSeS/ZnS structure (core/shell or core/first shell/second shell).

In addition, the nano particle may include the compound semiconductor of at least two metals. In detail, the nano particle may include group II-VI compound semiconductors of a first group II element and a second group II element. In more detail, the nano particle may consist of the compound semiconductor of at least two metals. For instance, the nano particle may include the compound semiconductor expressed as following chemical formula 1.

A_{X}B_{1-X}D_{Y}E_{1-Y} Chemical Formula 1

In the above chemical formula, A is a group II element, B is another group II element different from A, D is a group VI element, and E is another group VI element different from D (0<X<1, 0<Y<1). In addition, X may be gradually reduced from the center of the nano particle. In detail, A may be Cd, B may be Zn, D may be S, and E may be Se.

The nano particle may have a spherical shape. The nano particle may have a diameter in the range of about 1 nm to about 10 nm.

The protective layer surrounds the nano particle. The protective layer is deposited on an outer surface of the nano particle. That is, the protective layer can be deposited on the outer surface of the nano particle. In detail, the protective layer is directly formed on the outer surface of the nano particle. The protective layer is coated on the outer surface of the nano particle. The protective layer is coated on the entire area of the outer surface of the nano particle. The protective layer may seal the nano particle. The protective layer may have a thickness in the range of about 2 Å to about 10 nm.

The protective layer includes oxide. In detail, the protective layer includes metal oxide. The metal oxide may be the oxide of group II elements. In addition, the metal oxide may include one selected from the group consisting of cadmium oxide, zinc oxide, tin oxide and titanium oxide.

In addition, the nano particle may include the compound semiconductor including a first metal element, and the protective layer may include oxide of a second metal element different from the first metal element.

Further, the nano particle includes the group II-VI compound semiconductor and the protective layer includes oxide of the group II element.

The nano particle has the core/shell structure and the protective layer directly makes contact with the shell. The protective layer may include oxide of a metal different from the group II element included in the shell.

In addition, when the nano particle includes the compound semiconductors of the first group II element and the second group II element, the protective layer may include oxide of the first group II element or oxide of the second group II element.

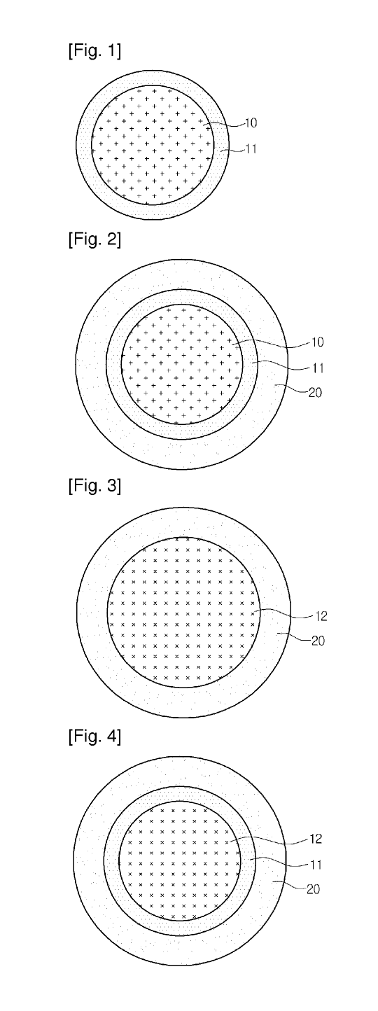

FIG. 1 is a sectional view showing a nano particle complex according to the first embodiment, FIG. 2 is a sectional view showing a nano particle complex according to the second embodiment, FIG. 3 is a sectional view showing a nano particle complex according to the third embodiment and FIG. 4 is a sectional view showing a nano particle complex according to the fourth embodiment.

Referring to FIG. 1, the nano particle 10 can be formed by using a single material. For instance, the nano particle 10 may be formed by using a group II-VI compound semiconductor. In addition, the group II-VI compound semiconductor included in the nano particle 10 may have the constant composition as a whole. For instance, the nano particle 10 may include CdS, CdTe or CdSe.

The protective layer 20 surrounds the nano particle 10. The protective layer 20 is deposited on the outer surface of the nano particle 10. The protective layer 20 may be directly coated on the outer surface of the nano particle 10.

The protective layer 20 may include oxide of a metal included in the nano particle 10. For instance, the nano particle 10 may include cadmium oxide. The nano particle 10 may consist of the cadmium oxide.

In contrast, the protective layer 20 may include oxide of a metal, which is not included in the nano particle 10.

If the nano particle 10 includes the group II-VI compound semiconductor, the protective layer 20 may include oxide of a metal different from the group II element. In detail, the protective layer 20 may consist of oxide of a metal different from the group II element. For instance, if the nano particle 10 includes CdS, CdTe or CdSe, the protective layer 20 may include aluminum oxide, titanium oxide or tin oxide.

In addition, the protective layer 20 may include oxide of the group II element different from the group II element used for the nano particle 10. In detail, the protective layer 20 may consist of oxide of the group II element different from the group II element used for the nano particle 10. For instance, if the nano particle 10 includes CdS, CdTe or CdSe, the protective layer 20 may include zinc oxide.

Referring to FIG. 2, the nano particle may include the core 10/shell 11 structure. The core 10 may include the first group II-VI compound semiconductor and the shell 11 surrounding the core 10 may include the second group II-VI compound semiconductor. In addition, although not shown in the drawing, the shell 11 may have the multi-layer structure. The nano particle may include the CdSe/ZnS, CdSe/ZnSe/ZnS, CdS/ZnS or CdSe/CdZnSeS/ZnS structure (core/shell or core/first shell/second shell). In detail, the core 10 may include a Cd compound and the shell 11 may include a Zn compound.

The protective layer 20 directly makes contact with the shell 11. In detail, the protective layer 20 is directly deposited on the shell 11. The protective layer 20 is coated on the entire area of the outer surface of the shell 11.

The protective layer 20 may include oxide of a metal included in the shell 11. For instance, if the shell 11 includes ZnS or ZnSe, the protective layer 20 may include zinc oxide. The protective layer 20 may consist of zinc oxide.

In contrast, the protective layer 20 may include oxide of a metal, which is not included in the shell 11.

If the shell 11 includes the group II-VI compound semiconductor, the protective layer 20 may include oxide of a metal different from the group II element. In detail, the protective layer 20 may consist of oxide of a metal different from the group II element. For instance, if the shell 11 includes CdS, CdTe or CdSe, the protective layer 20 may include aluminum oxide, titanium oxide or tin oxide.

In addition, the protective layer 20 may include oxide of the group II element different from the group II element used for the shell 11. In detail, the protective layer 20 may consist of oxide of the group II element different from the group II element used for the shell 11. For instance, if the shell 11 includes ZnS, ZnTe or ZnSe, the protective layer 20 may include cadmium oxide.

Referring to FIG. 3, the nano particle 12 may include the compound semiconductor of at least two metals. In detail, the nano particle 12 may include group II-VI compound semiconductors of a first group II element and a second group II element. In more detail, the nano particle 12 may consist of the compound semiconductor of at least two metals. For instance, the nano particle may include the compound semiconductor expressed as above chemical formula 1. In other words, the nano particle 12 may include a Cd-Zn-S-Se compound semiconductor.

The protective layer 20 is directly formed on the outer surface of the nano particle 12. The protective layer 20 may include oxide of a metal different from the metal included in the nano particle 12. In detail, the protective layer 20 may consist of oxide of a metal different from the metal included in the nano particle 12. For instance, if the nano particle 12 includes a Cd-Zn-S-Se compound semiconductor, the protective layer 20 may include aluminum oxide, titanium oxide or tin oxide.

The protective layer 20 may include oxide of one of metals included in the nano particle 12. In detail, the protective layer 20 may consist of oxide of one of metals included in the nano particle 12. For instance, if the nano particle 12 includes a Cd-Zn-S-Se compound semiconductor, the protective layer 20 may include cadmium oxide or zinc oxide.

Referring to FIG. 4, the nano particle may include the core 12/shell 11 structure. The core 12 may include the compound semiconductor of at least two metals. At this time, the core 12 may include the compound semiconductor of at least two metals. In detail, the core 12 may include group II-VI compound semiconductors of a first group II element and a second group II element. In more detail, the core 12 may consist of the compound semiconductor of at least two metals. For instance, the core 12 may include the compound semiconductor expressed as above chemical formula 1. In other words, the core 12 may include a Cd-Zn-S-Se compound semiconductor.

The shell 11 surrounds the core 12 and includes the group II-VI compound semiconductor. The shell 11 may include the compound semiconductor of one metal. For instance, the shell 11 may include at least one of ZnS, ZnSe and ZnTe. In addition, although not shown in the drawing, the shell 11 may have the multi-layer structure.

The protective layer 20 directly makes contact with the shell 11. In detail, the protective layer 20 is directly deposited on the shell 11. The protective layer 20 is coated on the entire area of the outer surface of the shell 11.

The protective layer 20 may include oxide of a metal included in the shell 11. For instance, if the shell 11 includes ZnS or ZnSe, the protective layer 20 may include zinc oxide. The protective layer 20 may consist of zinc oxide.

In contrast, the protective layer 20 may include oxide of a metal, which is not included in the shell 11.

If the shell 11 includes the group II-VI compound semiconductor, the protective layer 20 may include oxide of a metal different from the group II element. In detail, the protective layer 20 may consist of oxide of a metal different from the group II element. For instance, if the shell 11 includes CdS, CdTe or CdSe, the protective layer 20 may include aluminum oxide, titanium oxide or tin oxide.

In addition, the protective layer 20 may include oxide of the group II element different from the group II element used for the shell 11. In detail, the protective layer 20 may consist of oxide of the group II element different from the group II element used for the shell 11. For instance, if the shell 11 includes ZnS, ZnTe or ZnSe, the protective layer 20 may include cadmium oxide.

In order to fabricate the nano particle complex according to the embodiment, the nano particle may be provided. The nano particle can be fabricated through the metal organic chemical vapor deposition (MOCVD).

In addition, the nano particle can be fabricated through the wet chemical scheme. In detail, a solvent including a source of a group VI element is heated up to the reaction temperature. Then, a metallic precursor is instantly injected into the solvent, thereby synthesizing the nano particle.

In addition, the metallic precursor and the source of the group VI element are mixed with the solvent and then the mixture is heated up to the reaction temperature, thereby synthesizing the nano particle. If the nano particle has the core/shell structure, the core is formed through the wet chemical scheme and then the shell is formed through the above process.

The metallic precursor may include alkylcarboxylic acid metal complex. For instance, the metallic precursor may include metallic complex compound of oleic acid, stearic acid, myristic acid or lauric acid. The metal of the metallic complex compound may include Cd or Zn. In addition, the metallic precursor may include Cd(OH)₂, CdO, Zn(OH)₂ or ZnO.

The source of the group VI element may include the compound of Se, S or Te. For instance, the source of the group VI element may include trioctylphosphine selenium (TOPSe), trioctylphosphine sulfide (TOPS), trioctylphosphine tellurium (TOPTe), tributylphosphine selenium (TBPSe), tributylphosphine sulfide (TBPS), tributylphosphine tellurium (TBPTe), triisopropylphosphine selenium (TPPSe), triisopropylphosphine sulfide (TPPS) or triisopropylphosphine tellurium (TPPTe).

In addition, the nano particle may include the compound semiconductor of at least two metals. In order to form the compound semiconductor of at least two metals, at least two types of the metallic precursors may be used. For instance, after mixing a cadmium precursor and a zinc precursor in the solvent together with the source of the group VI element, the nano particle can be formed through the reaction.

Then, the protective layer is formed around the nano particle. In order to form the protective layer, the nano particles are uniformly dispersed in the solvent. The solvent may include an organic solvent. For instance, the solvent may include 1-octadecene, toluene or trioctylphosphine oxide.

After that, an organometallic compound is added to the solvent where the nano particles are dispersed to form the protective layer. The organometallic compound is a source of metal oxide used as the protective layer. The amount of the organometallic compound added to the solvent can be variously adjusted depending on the amount of the nano particles mixed in the solvent and the thickness of the protective layer.

The organometallic compound may have the direct bonding structure of metal and oxygen. In detail, the organometallic compound may include carboxylate or alkoxide. That is, the organometallic compound is the metallic salt of carboxyl acid or alcohol.

For instance, the organometallic compound includes a metallic complex compound of acetic acid, oleic acid, stearic acid, myristic acid or lauric acid. At this time, the metal included in the organometallic compound may include the group II element. In addition, the metal included in the organometallic compound may include Al, Sn or Ti.

The organometallic compound can be expressed as following chemical formula 2.

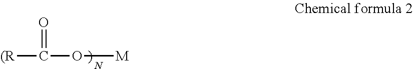

In the above chemical formula, M is metal, C is carbon and O is oxygen. In detail, M can be selected from the group consisting of Cd, Zn, Al, Sn and Ti. In addition, R can be selected from the group consisting of hydrogen, halogen element, alkyl group, aryl group and hetero aryl group. Further, N is an integer in the range of 1 to 8. The N may vary depending on the type of the M. In detail, the N is equal to the valance of the M. For instance, if the M is Cd or Zn, the N is 2.

The organometallic compound can be expressed as following chemical formula 3.

(R—O—)_{N}M Chemical Formula 3

In the above chemical formula, M is metal, and O is oxygen. In detail, M can be selected from the group consisting of Cd, Zn, Al, Sn and Ti. In addition, R can be selected from the group consisting of hydrogen, halogen element, alkyl group, aryl group, cyclo alkyl group and hetero aryl group. Further, N is an integer in the range of 1 to 8. The N may vary depending on the type of the M. In detail, the N is equal to the valance of the M. For instance, if the M is Cd or Zn, the N is 2.

In addition, a nucleophillic catalyst can be further added to the solvent including the organometallic compound. The nucleophillic catalyst may promote the decomposition of the organometallic compound. The nucleophillic catalyst may include amine or phosphine. In detail, the nucleophillic catalyst may include alkylamine or alkylphosphin. In more detail, the nucleophillic catalyst may include octylamine, dioctylamine, oleylamine, trioctylphosphine or dioctylphosphine. At least 2 equivalents of the nucleophillic catalyst may be added to the solvent based on the organometallic compound.

After that, the reaction solution including the organometallic compound and the nucleophillic catalyst is heated. Thus, the temperature of the reaction solution may rise and the organometallic compound is decomposed. In particular, the nucleophillic catalyst promotes the decomposition of the organometallic compound to form an intermediate, such as metal hydroxide. Then, the metal hydroxide forms metal oxide through the condensation reaction. The metal oxide is deposited around the nano particle so that the protective layer is formed. At this time, the reaction temperature of the reaction system is in the range of about 50° C. to about 350° C. In addition, the reaction time of the reaction system is in the range of about 1 minute to about 60 minutes.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effects such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### EXPERIMENTAL EXAMPLE 1

About 100 mg of CdSe nano particles having a diameter of about 4 nm was dispersed in about 20 ml of 1-octadecene. Then, about 0.5 mmol of Cd-oleate and about 1 ml of oleylamine were added to the solution. The solution was heated up to the temperature of about 250° C. in the nitrogen current and then maintained for 10 minutes. After that, the temperature of the reaction system was cooled down to the normal temperature and acetone was added. Then, the nano particle complex formed with the protective layer including cadmium oxide was isolated through the centrifugation. The above purification process was performed three times.

### EXPERIMENTAL EXAMPLE 2

The protective layer was formed on an outer surface of about 100 mg of CdSe/ZnS nano particles having a diameter of about 5 nm, similarly to experimental example 1.

### EXPERIMENTAL EXAMPLE 3

About 0.0439 g (0.3 mmol) of Cd(OH)2, about 0.398 g (4 mmol) of Zn(OH)2, about 5 ml of oleic acid, about 10 ml of 1-octadecene, about 3 ml of trioctylphosphine, about 0.032 g (0.4 mmol) of selenium and about 0.128 g (4 mmol) of sulfide were dissolved and mixed with each other. Then, the reaction system was heated up to about 300° C. at the rate 18° C. of/min. After that, the temperature of the reaction system was maintained for about 10 minutes. Then, the temperature of the reaction system was cooled down to the normal temperature and acetone was added to immerse the nano particles therein. After that, the nano particles were separated through the centrifugation. Then, the nano particles were dispersed by hexane and isolated and purified by acetone. The above process was performed three times.

About 100 mg of the nano particles obtained through the above process was dispersed in about 10 ml of 1-octadecene. Then, the protective layer including cadmium oxide was formed on an outer surface of a quantum dot through a method similar to the method of experimental example 1.

### EXPERIMENTAL EXAMPLE 4

About 100 mg of CdSe/ZnS nano particles having a diameter of about 5 nm was dispersed in about 10 ml of 1-octadecene. Then, about 0.5 mmol of Zn-oleate and about 1 ml of oleylamine were added to the solution. The solution was heated up to the temperature of about 250° C. in the nitrogen current and then maintained for 10 minutes. After that, the nano particle complex having the protective layer was obtained through a method similar to the method of experimental example 1.

### COMPARATIVE EXAMPLE 1 to 3

The nano particles of experimental examples 1 to 3 having no protective layer were provided as the nano particles of comparative examples 1 to 3.

### COMPARATIVE EXAMPLE 4

Similar to comparative example 2, about 100 mg of CdSe/ZnS nano particles having a diameter of about 5 nm was dispersed in about 10 ml of 1-octadecene. Then, the solution was heated up to the temperature of about 130° C. and about 0.2 g of trimethylamine-N-oxide dihydrate was add to the solution as an oxidant. After that, the outer surface of the nano particle was oxidized for about 30 minutes, so that an oxide layer was formed.

Result 1

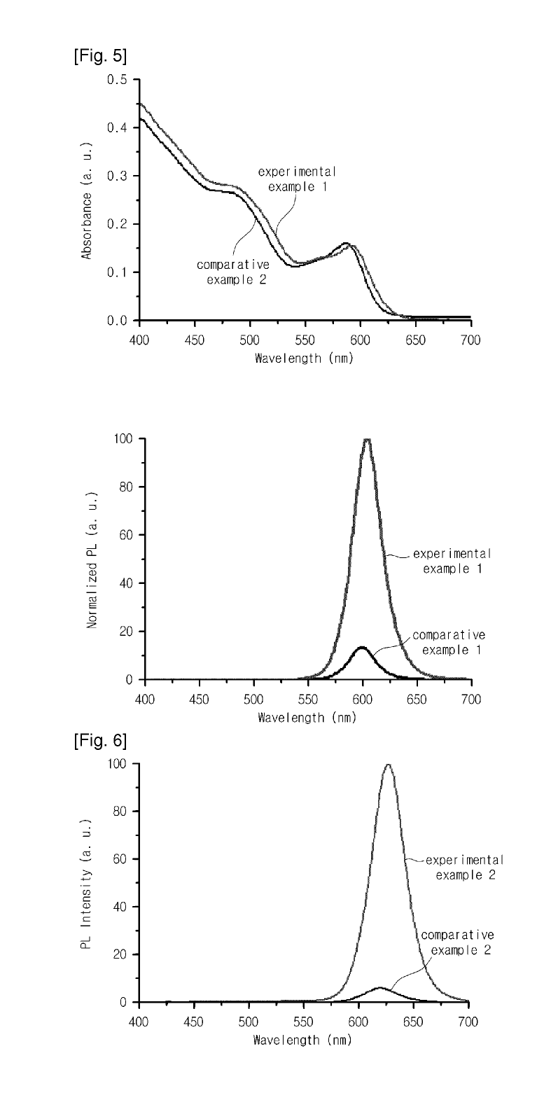

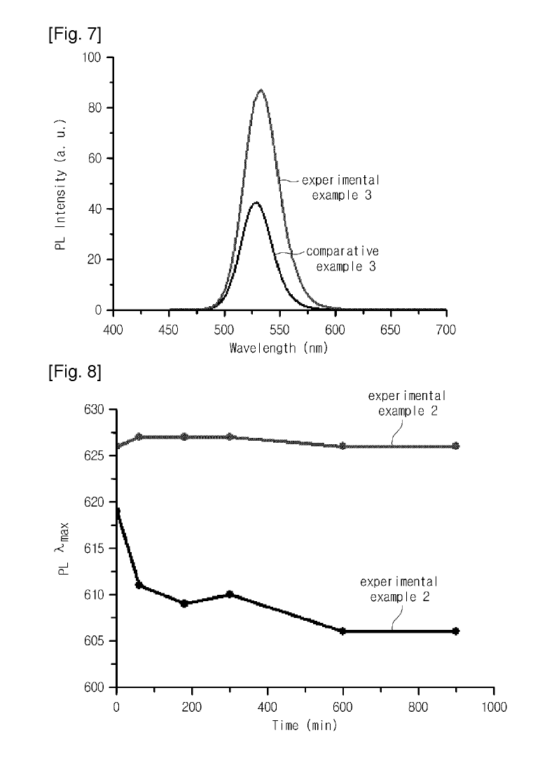

The nano particles of comparative examples 1 to 3 and the nano particle complex of experimental examples 1 to 3 were dispersed in the organic solvent at the same density and ultraviolet rays having the same wavelength were irradiated. The intensity of the light having the wavelength converted by the nano particles and the nano particle complex was shown in FIGS. 5 to 7. As shown in FIGS. 5 to 7, the nano particle complex of experimental examples 1 to 3 represented the improved efficiency.

Result 2

The light having high intensity was irradiated to the nano particles of comparative example 2 and the nano particle complex of experimental example 2 by using a halogen lamp having the power of 200W. The light irradiation time and the modification degree were shown in FIG. 8. As shown in FIG. 8, the nano particle complex of experimental example 2 represented the improved stability.

Result 3

In the case of comparative example 4, after the oxidant was added to oxidize the surface of the nano particle, the light emitting efficiency was lowered and the luminosity has disappeared after 5 minutes has lapsed.

Result 4

The nano particles of comparative example 2 and the nano particle complex of experimental example 2 were washed several times by using acetone, respectively. The performance degradation according to the frequency of the washing processes was checked. After the nano particles and the nano particle complex have been washed four times, the efficiency of the nano particle complex of experimental example 2 was lowered by about 10% and the efficiency of the nano particles of comparative example 2 was lowered by about 80%.

1. A nano particle complex comprising:
a nano particle including a compound semiconductor; and
a protective layer surrounding the nano particle and including a metal oxide.

2. The nano particle complex of claim 1, wherein the protective layer is deposited on an outer surface of the nano particle.

3. The nano particle complex of claim 1, wherein the compound semiconductor of the nano particle includes a first metal element, and the metal oxide includes an oxide of a second metal element different from the first metal element.

4. The nano particle complex of claim 1, wherein the nano particle includes a group II-VI compound semiconductor and the protective layer includes an oxide of a group II element.

5. The nano particle complex of claim 1, wherein the nano particle comprises:
a core including a first group II-VI compound semiconductor; and
a shell surrounding the core and including a second group II-VI compound semiconductor,
wherein the protective layer directly makes contact with the shell.

6. The nano particle complex of claim 5, wherein the metal oxide is an oxide of a metal different from a group II element included in the shell.

7. The nano particle complex of claim 1, wherein the nano particle includes a compound of a first group II element and a second group II element, and the protective layer includes an oxide of the first group II element or the second group II element.

8. The nano particle complex of claim 1, wherein the metal oxide includes one selected from the group consisting of a cadmium oxide, a zinc oxide, a tin oxide, an aluminum oxide, and a titanium oxide.

9. A nano particle complex comprising:
a nano particle including a compound semiconductor; and
a protective layer deposited on an outer surface of the nano particle and including an oxide.

10. The nano particle complex of claim 9, wherein the oxide includes one selected from the group consisting of a cadmium oxide, a zinc oxide, a tin oxide, an aluminum oxide, and a titanium oxide.

11. The nano particle complex of claim 9, wherein the nano particle has a diameter in a range of 1 nm to 10 nm.

12-20. (canceled)
